(19) United States
(12) Patent Application Publication
(10) Pub. No.: US 2003/0153274 A1
(43) Pub. Date: Aug. 14, 2003

(54) Doppler spread estimation

(76) Inventors: Carsten Juncker, Lyngby (DK); Peter Toft, Greve (DK); Niels Jacob Sand Morch, Frederiksberg (DK)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/073,909

(22) Filed: Feb. 14, 2002

(51) Int. Cl. H04B 17/00

(52) U.S. Cl. 455/67.6; 342/99

(57) ABSTRACT

The Doppler spread of a received signal is estimated from the derivative of the path transfer function envelope for the received signal. The estimated Doppler spread is used to estimate the speed of a mobile station.

### FIELD OF THE INVENTION

The present invention relates to the estimation of Doppler spread and mobile stations speed.

### BACKGROUND TO THE INVENTION

A radio signal from a transmitter to a receiver will travel along different propagation paths as the signal is scattered by obstacles, such as houses and other objects. This leads to signals received with different time delays, so called multipath propagation. When the receiver starts moving Doppler shifts will be introduced. When several paths arrive at the same time delay a Doppler spread, or Doppler spectrum, is generated.

Knowledge of the Doppler spread has been found to be useful for enhancing the operation of receivers as described, for example, in Morelli, M. et al., “Further Results in Carrier Frequency Estimation for Transmissions Over Flat Fading Channels”, IEEE Communications Letters vol. 2, no. 12, December 1998. The Doppler spread can also be used to infer the scalar speed of a receiver relative to local radio reflectors. This scalar speed is not the radial velocity that one can determine by measuring a Doppler shift. In most cases, the speed will correspond to the speed of the receiver, such as in the case of a receiver in a moving car surrounded by stationary street furniture.

### SUMMARY OF THE INVENTION

The present inventors have established that the Doppler spread associated with a transmission path can be estimated reliably from the derivative of the transmission path's transfer function.

According to the present invention, there is provided a method of estimating the Doppler spread of a radio signal, the method comprising

receiving a radio signal;

deriving a value for the derivative of the envelope of the path transfer function for said radio signal; and

computing an estimate of the Doppler spread of said radio signal from said derivative value.

The transfer function of a path from a transmitter to a moving receiver is subject to three amplitude effects, namely path loss, slow fading and fast fading. It is the fast fading which is associated with Doppler spread. The fast fading operates at time scales many orders of magnitude smaller than path loss and slow fading. Accordingly, for a signal transmitted at a constant or slowly varying power, the derivative of the envelope of the received signal will be determined predominantly by the fast fading, i.e. Doppler spread, and the path loss and slow fading effects can be disregarded. Modulation effects can be compensated for by demodulating the received signal with a signal corresponding to the modulating signal which can be predetermined, for example by means of reference codes transmitted at predetermined times.

However, the path transfer function can be estimated by techniques, other than by demodulating the received signal with the modulating signal, such as that described in Wu, J. et al., “Blind Channel Estimation Based on Subspace for Multicarrier CDMA”, Vehicular Technology Conference, 2001. VTC 2001 Spring. IEEE VTS 53rd, Volume: 4, 2001.

In the minimal case of an unmodulated carrier, the received signal's envelope will be proportional to the transfer function of the path.

Preferably, therefore, said value for the derivative of said envelope is derived by low-pass filtering an envelope signal representing the path transfer function envelope to band limit it and filtering the band-limited envelope signal using an FIR filter. More preferably, said envelope signal comprises a sequence of samples representing the path transfer function envelope.

Preferably, the computing of said estimate of the Doppler spread comprises determining the variance of said derivative value. More preferably, the computing of said estimate of the Doppler spread comprises determining a value indicative of the received power of said radio signal. Still more preferably, the Doppler spread estimate is calculated by determining the square root of the result of dividing twice said variance by said value indicative of the received power of the radio signal.

Preferably, the Doppler spread estimate is calculated in accordance with the formula:

$$Doppler spread ∝ \sqrt{\frac{2 {\hat{b}}_{2}}{{\hat{b}}_{0}}}$$

$$where$$

$${\hat{b}}_{2} = \frac{1}{N} {\sum }_{n = 1}^{N} {\hat{\dot{r}}}_{nT}^{2} - {( \frac{1}{N} {\sum }_{n = 1}^{N} {\hat{\dot{r}}}_{nT} )}^{2}$$

$$and$$

$${\hat{b}}_{0} = \frac{1}{2 N} {\sum }_{n = 1}^{N} {r}_{nT}^{2}$$

where r is the magnitude of the radio signal.

According to the present invention, a Doppler spread, determined according to the present invention, is used to estimate the speed of a mobile station in a wireless communication system. The speed estimation method may perform processing applicable to different speed ranges, e.g a low speed range and a high speed range, in parallel and then select the more appropriate speed value as the final speed estimate.

According to the present invention, there are also provided mobile stations including processing means configured, e.g. by software, for performing methods according to the present invention.

### BRIEF DESCRIPTION OF THE DRAWINGS

FIG. 1 is a block diagram of a mobile station;

FIG. 2 is a flowchart illustrating a speed estimating program according to the present invention;

FIG. 3 is a flowchart illustrating a signal conditioning process of the program of FIG. 2;

FIG. 4 is a flowchart illustrating a speed estimating process of the program of FIG. 2; and

FIG. 5 is a flowchart illustrating a speed estimate selection process of the program of FIG. 2.

### DETAILED DESCRIPTION OF THE PREFERRED EMBODIMENT

A preferred embodiment of the present invention will now be described, by way of example, with reference to the accompanying drawings.

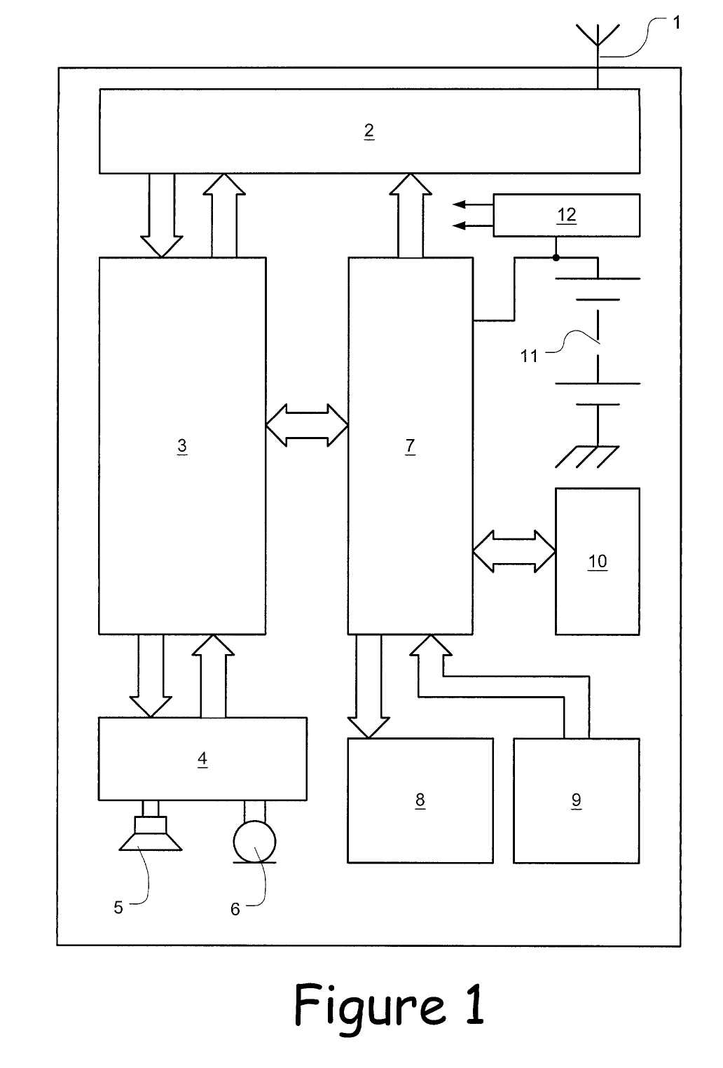

Referring to FIG. 1, a WCDMA mobile station comprises an antenna 1, an rf subsystem 2, a baseband DSP (digital signal processor) subsystem 3, an analogue audio subsystem 4, a loudspeaker 5, a microphone 6, a controller 7, a liquid crystal display 8, a keypad 9, memory 10, a battery 11 and a power supply circuit 12.

The rf subsystem 2 contains if and rf circuits of the mobile telephone's transmitter and receiver and a frequency synthesizer for tuning the mobile station's transmitter and receiver. The antenna 1 is coupled to the rf subsystem 2 for the reception and transmission of radio waves.

The baseband DSP subsystem 3 is coupled to the rf subsystem 2 to receive baseband signals therefrom and for sending baseband modulation signals thereto. The baseband DSP subsystems 3 includes codec and RAKE functionality, which are well-known in the art, and is programmed for estimating a received signal Doppler spread and the speed of the mobile station.

The analogue audio subsystem 4 is coupled to the baseband DSP subsystem 3 and receives demodulated audio therefrom. The analogue audio subsystem 4 amplifies the demodulated audio and applies it to the loudspeaker 5. Acoustic signals, detected by the microphone 6, are pre-amplified by the analogue audio subsystem 4 and sent to the baseband DSP subsystem 3 for coding.

The controller 7 controls the operation of the mobile telephone. It is coupled to the rf subsystem 2 for supplying tuning instructions to the frequency synthesizer and to the baseband DSP subsystem 3 for supplying control data and management data for transmission. The controller 7 operates according to a program stored in the memory 10. The memory 10 is shown separately from the controller 7. However, it may be integrated with the controller 7.

The display device 8 is connected to the controller 7 for receiving control data and the keypad 9 is connected to the controller 7 for supplying user input data signals thereto.

The battery 1 is connected to the power supply circuit 12 which provides regulated power at the various voltages used by the components of the mobile telephone.

The controller 7 is programmed to control the mobile station for speech and data communication and with application programs, e.g. a WAP browser, which make use of the mobile station's data communication capabilities.

In order to estimate the speed of the mobile station, the DSP subsystem 3 is programmed to perform calculations appropriate for low and high speeds in parallel and then select the appropriate result.

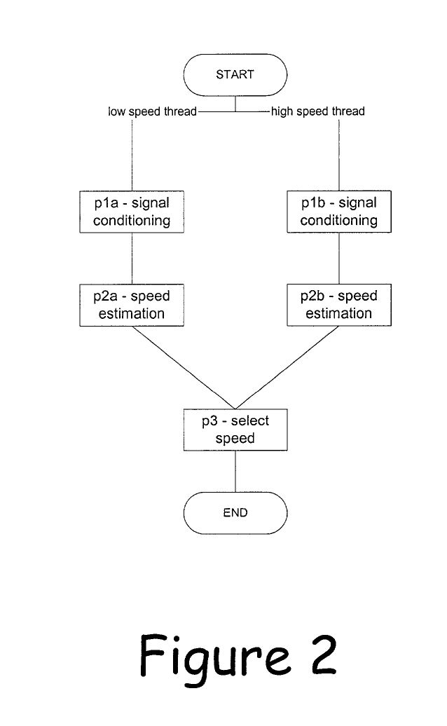

Referring to FIG. 2, the speed estimation program of the DSP subsystem 3 receives a stream of in-phase and quadrature baseband signal components and provides samples time-domain of the transfer function (H) of the signal paths having the various delays handled by the RAKE processing. In the present example, these transfer function samples are obtained by demodulating the received signal for reference symbols with values representing the transmitted signal.

Signal conditioning is performed on the transfer function samples (step p1a and p1b) using algorithms adapted for low and high speed ranges respectively. The low and high speed ranges overlap in the present example. However, the upper edge of the lower range may simply meet the lower edge of the upper range. The conditioned signals are then used to produce speed estimates (steps p2a and p2b) and the appropriate speed estimate is selected (step p3).

The signal conditioning processes p1a, p1b loop through the RAKE fingers which process transfer function signals for respective different path delays. Of course, if the mobile station does not employ a RAKE system, such as where the mobile station is not a CDMA device, there will be no need for this loop.

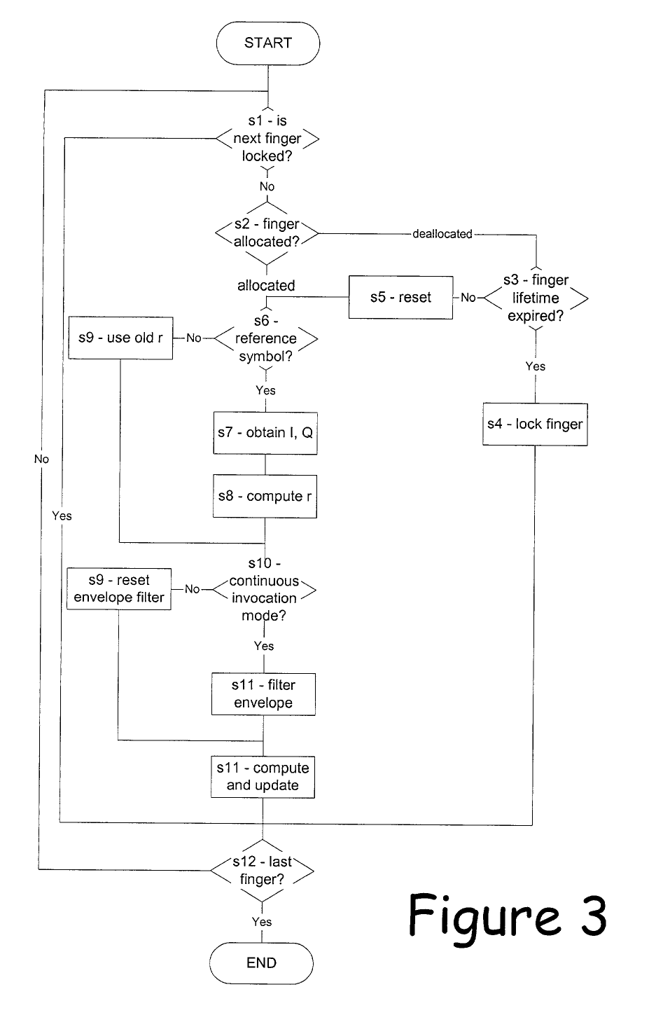

Referring to FIG. 3, in the low speed signal conditioning estimation process p1a, it is first determined whether the RAKE finger to be processed is locked (step s1). A “locked” finger is one whose allocated lifetime has expired. If the finger is locked at step s1, processing for the current finger is skipped.

However, if the current finger is not locked at step s1, the state of the finger, i.e. deallocated or allocated to a radio path, is determined (step s2).

In the case of the current finger being in the deallocated state at step s2, it is determined whether the finger's lifetime has expired (step s3). If the finger's lifetime has expired at step s3, the finger is locked (step s4) and further processing for it is skipped. However, if the finger's lifetime has not expired at step s3, all variables and parameters for the current finger are reset (step s5).

In the case of the current finger being allocated at step s2 and following step s5, it is determined whether a valid reference symbol has been detected (step s6). The reference symbols occur regularly in signals transmitted to the mobile station and have known and values. Therefore, values associated with like signals are used for calculation of the Doppler spread and speed. In the present case, the power at which the reference signals are transmitted is constant. However, if the power at which they are transmitted varies sufficiently quickly to affect the determined derivative value for the envelope, the magnitude of the envelope can be normalised using information about their transmission power. This information may be provided in control channels, for example.

If a valid reference symbol has been detected, in-phase (I) and quadrature (Q) component values for the transfer function are obtained (step s7). When the aforementioned I and Q values have been obtained, they are used to calculated the magnitude of the transfer function's envelope (r) (step s8).

However, if a valid reference symbol has not been detected, the previous value of transfer function's envelope magnitude is used to avoid gaps in the sequence of envelope magnitude values (step s9).

When the envelope magnitude value has been obtained, it is determined whether continuous invocation mode is being used (step s10). Continuous invocation mode is the normal mode of operation with an envelope value be obtained for each slot, i.e. regularly and frequently. However, under some circumstances, the speed estimation program may not be run in some slots. For instance the program may not be called during the transmission gap in compressed mode.

If operation is continuous, the new envelope magnitude value is fed into a low-pass filtering process (step s11). The low-pass filtering is provided by implementing a 3^{rd} order Butterworth IIR filter with a cutoff at 500 Hz. The filtering process for the low speed thread also performs downsampling by a factor of 2. The bandwidth of the filter is set to twice the maximum Doppler shift that can occur in the speed range covered. Thus, 500 Hz corresponds approximately to a speed of 125 km/h at 2.17 GHz.

If the operation is discontinuous, the filtering process s11 is skipped and the output of the filtering process s11 is replaced with the current envelope magnitude value.

The result of the filtering process s11 or the current envelope magnitude, as the case may be, is used to calculate the square of the envelope magnitude (rₜ²), the derivative of the envelope magnitude (\dot{r}ₜ) and the square of the derivative of the envelope magnitude

$$( {\dot{r}}_{t}^{2} ) .$$

Since, the envelope magnitudes are time-spaced samples, the derivative is approximated in the low speed thread using:

$${\hat{\dot{r}}}_{t} = \frac{{r}_{t} - {r}_{t - Δ T}}{Δ T}$$

where \hat{ } indicates an approximate or estimated value and ΔT is the sampling interval. It can be seen that this is a two-tap FIR filter.

These values are used to update accumulated values

$${\sum }_{n = 1}^{N} {r}_{nT}^{2} , {\sum }_{n = 1}^{N} {\hat{\dot{r}}}_{nT} , {\sum }_{n = 1}^{N} {\hat{\dot{r}}}_{nT}^{2}$$

for the square of the envelope magnitude, the approximate derivative of the envelope magnitude and the square of the derivative of the envelope magnitude, where N is an observation window length in terms of sample. In the present example, N is 750.

If all of the fingers have been processed at step s12, the signal conditioning is complete. Otherwise, the process returns to step s1.

The high speed signal conditioning p1b is the same as the low speed signal conditioning except that the low-pass filter has a cut-off at 1 kHz rather than 500 kHz and the envelope magnitude derivative \dot{r}ₜ is approximated using:

$${\hat{\dot{r}}}_{t} = \frac{{r}_{t} - {r}_{t - 2 Δ T}}{2 Δ T}$$

which is a 3-tap FIR filter having a zero coefficient for the middle tap.

The bandwidth of the filter is set to twice the maximum Doppler shift that can occur in the speed range covered. Thus, 1 kHz corresponds approximately to a speed of 250 km/h at 2.17 GHz.

The results of the low speed and high speed signal conditioning process p1a, p1b are supplied to the low speed and high speed speed estimating processes p2a, p2b respectively.

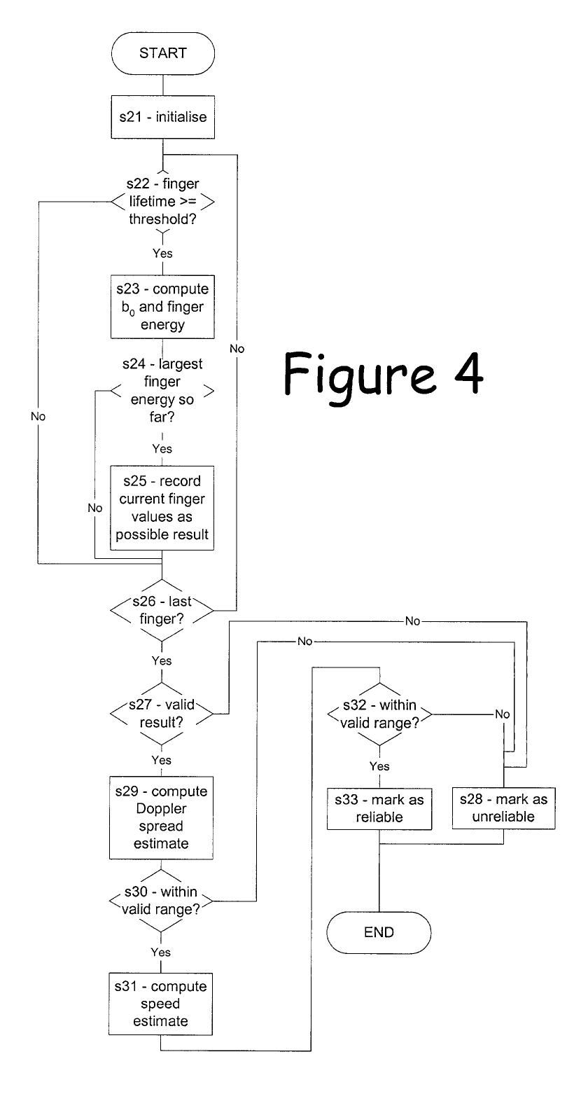

Referring to FIG. 4, at the start of the low speed speed estimating process p2a, an initialisation routine (step s21) sets a “finger valid flag” to true and a “maximum energy” variable to −1. After initialisation, the process enters a loop so that all of the RAKE fingers are processed in turn.

At the start of the loop, it is determined whether the current finger's lifetime is greater than or equal to a threshold (step s2). The threshold is set to identify fingers what are sufficiently old to provide sufficiently good data for reliable speed estimation. If the current finger's lifetime is less than the threshold, the process moves on to the next finger.

If at step s22, the current finger is sufficiently mature, a value \hat{b}₀ and an energy related value for the current finger are calculated (step s23). \hat{b}₀ is indicative of the power of the current finger and is calculated using:

$${\hat{b}}_{0} = \frac{1}{2} E \{ {r}^{2} \}$$

where E{r²} is the mean of

$${\sum }_{n = 1}^{N} {r}_{nT}^{2}$$

calculated at step s11 in FIG. 3.

The energy related value for the current finger is calculated by multiplying \hat{b}₀ by the current finger's age.

Following step s23, it is determined whether the current finger has the largest energy related value of the fingers processed so far (step s24) by comparing its energy with the “maximum energy” variable. If this is not the case, the process moves on to the next finger. However, if this is the case, the “finger valid flag” is set to true to indicate that data is now available for speed estimation, the “maximum energy” variable is set to the energy of the current finger and an index, identifying the current finger, is stored (step s25).

When all of the fingers have been processed (step s26), it is determined whether data suitable for speed estimation has been obtained by checking the state of the “finger valid flag” (step s27). If the “finger valid flag” is false, no further calculations are performed and the result of the low speed speed estimating process p2a is noted as being unreliable by setting a reliability flag to false. However, if the “finger valid flag” is true, the Doppler spread \hat{f}_{d}_{_{spread}} is estimated for the last finger whose index was stored at step s25 using:

$${\hat{f}}_{{d}_{spread}} = \frac{1}{2 π} \sqrt{\frac{{\hat{b}}_{2}}{{\hat{b}}_{0}}}$$

where

\hat{b}₂=E{\dot{\hat{r}}²}−(E{\dot{\hat{r}}})²

where E{\dot{\hat{r}}²} is the mean of

$${\sum }_{n = 1}^{N} {\hat{\dot{r}}}_{nT}^{2}$$

calculated at step s11 of FIG. 3 and E{\dot{\hat{r}}} is the mean of

$${\sum }_{n = 1}^{N} {\hat{\dot{r}}}_{nT}$$

calculated at step s11 of FIG. 3 (step s29).

The newly calculated Doppler spread estimate is checked to determine whether it falls within a range of valid values (step s30). If the Doppler spread estimate is outside the valid values range, the process proceeds to step s28. However, if it is within the valid values range, it is used to computer a speed estimate for the mobile station using:

$$\hat{v} = \frac{{\hat{f}}_{{d}_{spread}} c}{{f}_{c}}$$

where c is the velocity of light in free space and f_{c} is the carrier frequency of the signal being received. It is determined whether the newly estimated speed value is within a valid range, i.e. below 500 km/h in the present example. (step s32). If not, the process moves to step s28. If the speed value is valid, the reliability flag is set to true.

The high speed speed estimating process p2b is identical except for the valid value ranges used at steps s30 and s32.

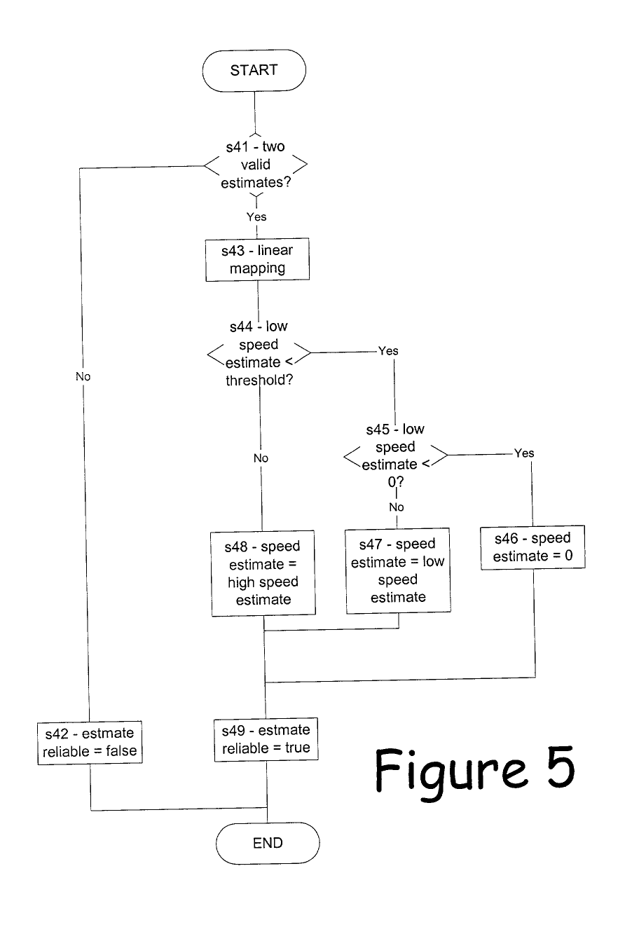

Referring to FIG. 5, when the speed estimation processes p2a, p2b have been completed, the speed selection process p3 determines whether both speed estimate process have produced reliable estimates (step s41). If one or both have not produced reliable estimates, as indicated by their respective reliability flags, no speed estimate is selected, a speed estimate reliability flag is set to false (step s42) and the process terminates.

If both speed estimation processes p2a, p2b produced valid speed estimates, the estimates are compensated for systematic errors introduced by the low-pass filtering and the speed estimation algorithm for low speeds (step s43). The compensation algorithm is a standard linear mapping of the form:

\hat{ν}_{compensated}=α(\hat{ν}+β)

and in the present example α=1.7 and β=−12 for the low speed speed estimate and α=1.1 and β=−20 for the high speed speed estimate.

It is then determined whether the compensated low speed speed estimate is less than a threshold located within the overlap between the low and high speed ranges (step s44). If the low speed speed estimate is less than the threshold, it is determined whether the estimate is less than 0 (step s45) and, if so, the final speed estimate is set to 0 (step s46). If the compensated low speed speed estimate is not less than 0 at step s45, the final speed estimate is set to the compensated low speed speed estimate (step s47).

If the compensated low speed speed estimate is not below the threshold at step s44, the final speed estimate is set to the compensated high speed speed estimate (step s48).

Following steps s46, s47 and s48, the speed estimate reliability flag is set to true.

If the speed estimate reliability flag is true, a speed estimate will now be available for use by the mobile station and can be reported to a fixed network node where it may be used to control handovers, for example.

It will be appreciated that many modifications may be made to the preferred embodiment described above. For example, additional loops may be introduced into the signal conditioning and speed estimating processes for iterating through different signal sources in the case of transmit diversity being used.

In the foregoing, speed estimates are determined for two speed ranges. However, calculations may be performed for more or fewer speed ranges as required. More ranges give better performance but at the cost of increased complexity. Also, higher order low-pass filters give better performance but again at the cost of increased complexity.

In the foregoing, the Doppler spread and speed calculations are performed in a mobile station. However, these calculations could be performed at a fixed network node using signal strength reports from a mobile station. Alternatively, the calculations could be performed in part by a mobile station, e.g. the signal conditioning processes, and in part by a fixed network node, e.g. the speed estimation and selection processes.

1. A method of estimating the Doppler spread of a radio signal, the method comprising
receiving a radio signal;
deriving a value for the derivative of the envelope of the path transfer function for said radio signal; and
computing an estimate of the Doppler spread of said radio signal from said derivative value.

2. A method according to claim 1, wherein said value for the derivative of said envelope is derived by low-pass filtering an envelope signal representing the path transfer function envelopepath transfer function envelope to band limit it and filtering the band-limited envelope signal using an FIR filter.

3. A method according to claim 2, wherein said envelope signal comprises a sequence of samples representing the path transfer function envelope.

4. A method according to claim 1, wherein the computing of said estimate of the Doppler spread comprises determining the variance of said derivative value.

5. A method according to claim 4, wherein the computing of said estimate of the Doppler spread comprises determining a value indicative of the received power of said radio signal.

6. A method according to claim 5, wherein the Doppler spread estimate is calculated by determining the square root of the result of dividing twice said variance by said value indicative of the received power of the radio signal.

7. A method according to claim 1, wherein the Doppler spread estimate is calculated in accordance with the formula:
$$Doppler spread ∝ \sqrt{\frac{2 {\hat{b}}_{2}}{{\hat{b}}_{0}}}$$
$$where$$
$${\hat{b}}_{2} = \frac{1}{N} {\sum }_{n = 1}^{N} {\hat{\dot{r}}}_{nT}^{2} - {( \frac{1}{N} {\sum }_{n = 1}^{N} {\hat{\dot{r}}}_{nT} )}^{2}$$
$$and$$
$${\hat{b}}_{0} = \frac{1}{2 N} {\sum }_{n = 1}^{N} {r}_{nT}^{2}$$
where r is the magnitude of the radio signal.

8. A method of estimating the speed of a mobile station in a wireless communication system, the method comprising:
receiving a radio signal;
deriving a value for the derivative of the envelope of the path transfer function for said radio signal;
computing an estimate of the Doppler spread of said radio signal from said derivative value; and
deriving a value for the speed of said mobile station from said Doppler spread estimate.

9. A method according to claim 8, wherein said value for the derivative of said envelope is derived by low-pass filtering an envelope signal representing the path transfer function envelope to band limit it and filtering the band-limited envelope signal using an FIR filter.

10. A method according to claim 9, wherein said envelope signal comprises a sequence of samples representing the path transfer function envelope.

11. A method according to claim 9, wherein the computing of said estimate of the Doppler spread comprises determining the variance of said derivative value.

12. A method according to claim 11, wherein the computing of said estimate of the Doppler spread comprises determining a value indicative of the received power of said radio signal.

13. A method according to claim 12, wherein the Doppler spread estimate is calculated by determining the square root of the result of dividing twice said variance by said value indicative of the received power of the radio signal.

14. A method according to claim 8, wherein the Doppler spread estimate is calculated in accordance with the formula:
$$Doppler spread ∝ \sqrt{\frac{2 {\hat{b}}_{2}}{{\hat{b}}_{0}}}$$
$$where$$
$${\hat{b}}_{2} = \frac{1}{N} {\sum }_{n = 1}^{N} {\hat{\dot{r}}}_{nT}^{2} - {( \frac{1}{N} {\sum }_{n = 1}^{N} {\hat{\dot{r}}}_{nT} )}^{2}$$
$$and$$
$${\hat{b}}_{0} = \frac{1}{2 N} {\sum }_{n = 1}^{N} {r}_{nT}^{2}$$
where r is the magnitude of the radio signal.

15. A method according to claim 8, wherein the speed of the mobile station is calculated in accordance with the formula:
$$speed ∝ \frac{{f}_{{d}_{spread}}}{{f}_{c}}$$
where f_{dspread} is the Doppler spread and f_{c} is the carrier frequency of said radio signal.

16. A method of estimating the speed of a mobile station in a wireless communication system, the method comprising:
receiving a radio signal;
deriving first and second values for the derivative of the envelope of said radio signal;
computing first and second estimates of the Doppler spread of said radio signal from said derivative values; and
deriving a value for the speed of said mobile station from said Doppler spread estimates.

17. A method according to claim 16, wherein said first value for the derivative of the envelope of said radio signal is derived by derived by low-pass filtering an envelope signal representing the path transfer function envelope to band limit it and filtering the band-limited envelope signal using an FIR filter and said second value for the derivative of the envelope of said radio signal is derived by low-pass filtering an envelope signal representing the path transfer function envelope to band limit it and filtering the band-limited envelope signal using an FIR filter, the first value being derived using a low-pass filter characteristic having a lower cut-off frequency than that of the low-pass filter characteristic used for deriving said second value.

18. A method according to claim 17, wherein the output of the low-pass filtering for the first value is followed by downsampling.

19. A method according to claim 17, wherein said envelope signal comprises a sequence of samples representing the path transfer function envelope.

20. A method according to claim 17, wherein the computing of said first and second estimates of the Doppler spread comprises determining the variances of said first and second derivative values respectively.

21. A method according to claim 20, wherein the computing of each of said estimates of the Doppler spread comprises determining a value indicative of the received power of said radio signal.

22. A method according to claim 21, wherein the first and second Doppler spread estimates are calculated by determining the square root of the result of dividing twice the respective variance by said value indicative of the received power of the radio signal.

23. A method according to claim 16, wherein the Doppler spread estimatea are calculated in accordance with the formula:
$$Doppler spread ∝ \sqrt{\frac{2 {\hat{b}}_{2}}{{\hat{b}}_{0}}}$$
$$where$$
$${\hat{b}}_{2} = \frac{1}{N} {\sum }_{n = 1}^{N} {\hat{\dot{r}}}_{nT}^{2} - {( \frac{1}{N} {\sum }_{n = 1}^{N} {\hat{\dot{r}}}_{nT} )}^{2}$$
$$and$$
$${\hat{b}}_{0} = \frac{1}{2 N} {\sum }_{n = 1}^{N} {r}_{nT}^{2}$$
where r is the magnitude of the radio signal.

24. A method according to claim 16, comprising deriving first and second speed estimates values from the first and second Doppler spreads respectively and selecting the first or second speed estimate value in dependent on the magnitude of the first or second speed estimate value to provide said speed estimate.

25. A method according to claim 24, wherein the first and second speed estimate values are calculated in accordance with the formula:
$$speed ∝ \frac{{f}_{{d}_{spread}}}{{f}_{c}}$$
where f_{dspread} is a Doppler spread and f_{c} is the carrier frequency of said radio signal.

26. A mobile station of a wireless communication network, the mobile station including radio receiver means for receiving a radio signal and outputting a baseband signal and processing means for processing said baseband signal, wherein the processing means is configured for estimating the Doppler spread of a radio signal by deriving a value for the derivative of the envelope of the path transfer function envelope of a radio signal, received by said radio receiver means, and computing an estimate of the Doppler spread of said radio signal from said derivative value.

27. A mobile station according to claim 26, wherein said processing means is configured such that said value for the derivative of said envelope is derived by low-pass filtering an envelope signal representing the path transfer function envelope to band limit it and filtering the band-limited envelope signal using an FIR filter.

28. A mobile station according to claim 27, wherein the radio receiver means outputs said baseband signal as a plurality of samples.

29. A mobile station according to claim 26, wherein the processing means is configured such that the computing of said estimate of the Doppler spread comprises determining the variance of said derivative value.

30. A mobile station according to claim 29, wherein the processing means is configured such that the computing of said estimate of the Doppler spread comprises determining a value indicative of the received power of said radio signal.

31. A mobile station according to claim 30, wherein the processing means is configured such that the Doppler spread estimate is calculated by determining the square root of the result of dividing twice said variance by said value indicative of the received power of the radio signal.

32. A mobile station according to claim 26, wherein the processing means is configured such that the Doppler spread estimate is calculated in accordance with the formula:
$$Doppler spread ∝ \sqrt{\frac{2 {\hat{b}}_{2}}{{\hat{b}}_{0}}}$$
$$where$$
$${\hat{b}}_{2} = \frac{1}{N} {\sum }_{n = 1}^{N} {\hat{\dot{r}}}_{nT}^{2} - {( \frac{1}{N} {\sum }_{n = 1}^{N} {\hat{\dot{r}}}_{nT} )}^{2}$$
$$and$$
$${\hat{b}}_{0} = \frac{1}{2 N} {\sum }_{n = 1}^{N} {r}_{nT}^{2}$$
where r is the magnitude of the radio signal.

33. A mobile station of a wireless communication network, the mobile station including radio receiver means for receiving a radio signal and outputting a baseband signal and processing means for processing said baseband signal, wherein the processing means is configured for estimating the speed of the mobile station by deriving a value for the derivative of the path transfer function envelope for a radio signal, received by said radio receiver means, computing an estimate of the Doppler spread of said radio signal from said derivative value and deriving a value for the speed of said mobile station from said Doppler spread estimate.

34. A mobile station according to claim 33, wherein said processing means is configured such that said value for the derivative of said envelope is derived by low-pass filtering an envelope signal representing the path transfer function envelope to band limit it and filtering the band-limited envelope signal using an FIR filter.

35. A mobile station according to claim 34, wherein the radio receiver means outputs said baseband signal as a plurality of samples.

36. A mobile station according to claim 33, wherein the processing means is configured such that the computing of said estimate of the Doppler spread comprises determining the variance of said derivative value.

37. A mobile station according to claim 36, wherein the processing means is configured such that the computing of said estimate of the Doppler spread comprises determining a value indicative of the received power of said radio signal.

38. A mobile station according to claim 37, wherein the processing means is configured such that the Doppler spread estimate is calculated by determining the square root of the result of dividing twice said variance by said value indicative of the received power of the radio signal.

39. A mobile station according to claim 33, wherein the processing means is configured such that the Doppler spread estimate is calculated in accordance with the formula:
$$Doppler spread ∝ \sqrt{\frac{2 {\hat{b}}_{2}}{{\hat{b}}_{0}}}$$
$$where$$
$${\hat{b}}_{2} = \frac{1}{N} {\sum }_{n = 1}^{N} {\hat{\dot{r}}}_{nT}^{2} - {( \frac{1}{N} {\sum }_{n = 1}^{N} {\hat{\dot{r}}}_{nT} )}^{2}$$
$$and$$
$${\hat{b}}_{0} = \frac{1}{2 N} {\sum }_{n = 1}^{N} {r}_{nT}^{2}$$
where r is the magnitude of the radio signal.

40. A mobile station of a wireless communication network, the mobile station including radio receiver means for receiving a radio signal and outputting a baseband signal and processing means for processing said baseband signal, wherein the processing means is configured for estimating the speed of the mobile station by deriving first and second values for the derivative of the envelope of the path transfer function envelope of a radio signal, received by said radio receiver means, computing first and second estimates of the Doppler spread of said radio signal from said derivative value and deriving a value for the speed of said mobile station from said Doppler spread estimates.

41. A mobile station according to claim 40, wherein the processing means is configured such that said first value for the derivative of said envelope is derived by low-pass filtering an envelope signal representing the path transfer function envelope to band limit it and filtering the band-limited envelope signal using an FIR filter and said second value for the derivative of said envelope is derived by low-pass filtering an envelope signal representing the path transfer function envelope to band limit it and filtering the band-limited envelope signal using an FIR filter, the first value being derived using a low-pass filter characteristic having a lower cut-off frequency than that of the low-pass filter characteristic used for deriving said second value.

42. A mobile station according to claim 41, wherein the processing means is configured such that the output of the low-pass filtering for the first value is followed by downsampling.

43. A mobile station according to claim 41, wherein the radio receiver means outputs the baseband signal as a sequence of samples.

44. A mobile station according to claim 41, wherein processing means is configured such that the computing of said first and second estimates of the Doppler spread comprises determining the variances of said first and second derivative values respectively.

45. A mobile station according to claim 44, wherein the processing means is configured such that the computing of each of said estimates of the Doppler spread comprises determining a value indicative of the received power of said radio signal.

46. A mobile station according to claim 45, wherein processing means is configured such that the first and second Doppler spread estimates are calculated by determining the square root of the result of dividing twice the respective variance by said value indicative of the received power of the radio signal.

47. A mobile station according to claim 40, wherein processing means is configured such that the Doppler spread estimates are calculated in accordance with the formula:
$$Doppler spread ∝ \sqrt{\frac{2 {\hat{b}}_{2}}{{\hat{b}}_{0}}}$$
$$where$$
$${\hat{b}}_{2} = \frac{1}{N} {\sum }_{n = 1}^{N} {\hat{\dot{r}}}_{nT}^{2} - {( \frac{1}{N} {\sum }_{n = 1}^{N} {\hat{\dot{r}}}_{nT} )}^{2}$$
$$and$$
$${\hat{b}}_{0} = \frac{1}{2 N} {\sum }_{n = 1}^{N} {r}_{nT}^{2}$$
where r is the magnitude of the radio signal.

48. A mobile station according to claim 40, wherein the processing means is configured for deriving first and second speed estimate values from the first and second Doppler spreads respectively and selecting the first or second speed estimate value in dependent on the magnitude of the first or second speed estimate value to provide said speed estimate.

49. A mobile station according to claim 48, wherein the processing means is configured such that the first and second speed estimate values are calculated in accordance with the formula:
$$speed ∝ \frac{{f}_{{d}_{spread}}}{{f}_{c}}$$
where f_{dspread} is a Doppler spread and f_{c} is the carrier frequency of said radio signal.
